(19) United States
(12) Patent Application Publication
(10) Pub. No.: US 2016/0330653 A1
(43) Pub. Date: Nov. 10, 2016

(54) REDUCED CALL INTERRUPTION DURING TUNE AWAY IN MULTI-SUBSCRIBER IDENTITY MODULE/MULTI-STANDBY DEVICE

(71) Applicant: QUALCOMM Incorporated, San Diego, CA (US)

(72) Inventors: Ming YANG, San Diego, CA (US); Tom CHIN, San Diego, CA (US); Shaohong QU, San Diego, CA (US)

(21) Appl. No.: 14/705,953

(22) Filed: May 6, 2015

(51) Int. Cl. H04W 36/00; H04W 36/36

(52) U.S. Cl. CPC H04W 36/0016; H04W 36/36; H04W 88/06

(57) ABSTRACT

A multi-subscriber identity module (SIM) user equipment (UE) reduces call interruptions caused by tuning away. In one instance, the user equipment determines whether to abort a tune away procedure to a second subscriber identity module at the user equipment. The determination is based on a type of procedure running on a first subscriber identity module at the user equipment and/or a characteristic of an intended tune away to the second subscriber identity module.

### BACKGROUND

1. Field

Aspects of the present disclosure relate generally to wireless communication systems, and more particularly, to preventing or reducing call interruptions (e.g., dropped calls) caused by a multi-subscriber identity module (SIM) user equipment (UE) tuning away from a first communication entity to perform a communication activity for a second communication entity.

2. Background

Wireless communication networks are widely deployed to provide various communication services, such as telephony, video, data, messaging, broadcasts, and so on. Such networks, which are usually multiple access networks, support communications for multiple users by sharing the available network resources. One example of such a network is the universal terrestrial radio access network (UTRAN). The UTRAN is the radio access network (RAN) defined as a part of the universal mobile telecommunications system (UMTS), a third generation (3G) mobile phone technology supported by the 3rd Generation Partnership Project (3GPP). The UMTS, which is the successor to global system for mobile communications (GSM) technologies, currently supports various air interface standards, such as wideband-code division multiple access (W-CDMA), time division-code division multiple access (TD-CDMA), and time division-synchronous code division multiple access (TD-SCDMA). For example, China is pursuing TD-SCDMA as the underlying air interface in the UTRAN architecture with its existing GSM infrastructure as the core network. The UMTS also supports enhanced 3G data communications protocols, such as high speed packet access (HSPA), which provides higher data transfer speeds and capacity to associated UMTS networks. HSPA is a collection of two mobile telephony protocols, high speed downlink packet access (HSDPA) and high speed uplink packet access (HSUPA) that extends and improves the performance of existing wideband protocols.

As the demand for mobile broadband access continues to increase, research and development continue to advance the UMTS technologies not only to meet the growing demand for mobile broadband access, but to advance and enhance the user experience with mobile communications.

### SUMMARY

According to one aspect of the present disclosure, a method of wireless communication includes determining whether to abort a tune away procedure to a second subscriber identity module (SIM) at the user equipment (UE). The determination is based on a type of procedure running on a first SIM at the UE and/or a characteristic of an intended tune away to the second SIM.

According to another aspect of the present disclosure, an apparatus for wireless communication includes means for identifying a type of procedure running on a first subscriber identity module (SIM) at a user equipment (UE) and/or a characteristic of the intended tune away to a second SIM. The apparatus may also include means for determining whether to abort a tune away procedure to the second SIM at the UE. The determination is based on a type of procedure running on a first SIM at the UE and/or a characteristic of an intended tune away to the second SIM.

Another aspect discloses an apparatus for wireless communication and includes a memory and at least one processor coupled to the memory. The processor(s) is configured to determine whether to abort a tune away procedure to a second subscriber identity module (SIM) at the user equipment (UE). The determination is based on a type of procedure running on a first SIM at the UE and/or a characteristic of an intended tune away to the second SIM.

Yet another aspect discloses a computer program product for wireless communications in a wireless network having a non-transitory computer-readable medium. The computer-readable medium has non-transitory program code recorded thereon which, when executed by the processor(s), causes the processor(s) to determine whether to abort a tune away procedure to a second subscriber identity module (SIM) at the user equipment (UE). The determination is based on a type of procedure running on a first SIM at the UE and/or a characteristic of an intended tune away to the second SIM.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout.

FIG. 1 is a block diagram conceptually illustrating an example of a telecommunications system.

FIG. 2 is a block diagram conceptually illustrating an example of a frame structure in a telecommunications system.

FIG. 3 is a block diagram conceptually illustrating an example of a node B in communication with a UE in a telecommunications system.

FIG. 4 is a diagram illustrating network coverage areas according to aspects of the present disclosure.

FIG. 5 illustrates an example of a call flow diagram for a tune away method for the multi-subscriber identity module (SIM) multi-standby device in a wireless network according to aspects of the present disclosure

FIG. 6 is a block diagram illustrating a method for tuning away according to one aspect of the present disclosure.

FIG. 7 is a diagram illustrating an example of a hardware implementation for an apparatus employing a processing system according to one aspect of the present disclosure.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. However, it will be apparent to those skilled in the art that these concepts may be practiced without these specific details. In some instances, well-known structures and components are shown in block diagram form in order to avoid obscuring such concepts.

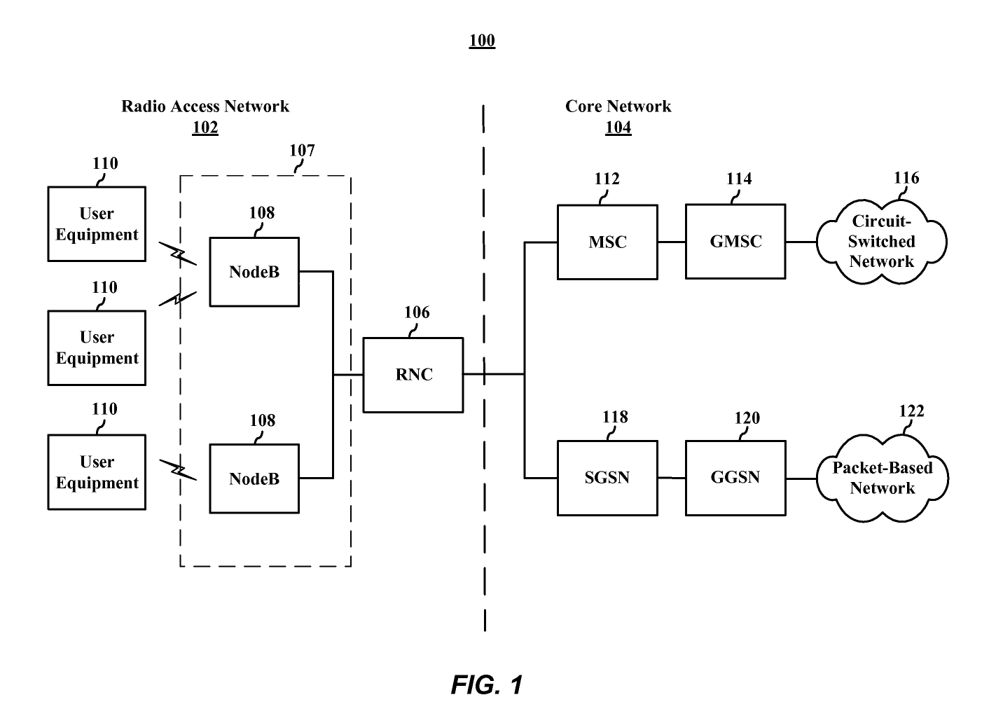

Turning now to FIG. 1, a block diagram is shown illustrating an example of a telecommunications system 100. The various concepts presented throughout this disclosure may be implemented across a broad variety of telecommunication systems, network architectures, and communication standards. By way of example and without limitation, the aspects of the present disclosure illustrated in FIG. 1 are presented with reference to a UMTS system employing a TD-SCDMA standard. In this example, the UMTS system includes a (radio access network) RAN 102 (e.g., UTRAN) that provides various wireless services including telephony, video, data, messaging, broadcasts, and/or other services. The RAN 102 may be divided into a number of radio network subsystems (RNSs) such as an RNS 107, each controlled by a radio network controller (RNC), such as an RNC 106. For clarity, only the RNC 106 and the RNS 107 are shown; however, the RAN 102 may include any number of RNCs and RNSs in addition to the RNC 106 and RNS 107. The RNC 106 is an apparatus responsible for, among other things, assigning, reconfiguring and releasing radio resources within the RNS 107. The RNC 106 may be interconnected to other RNCs (not shown) in the RAN 102 through various types of interfaces such as a direct physical connection, a virtual network, or the like, using any suitable transport network.

The geographic region covered by the RNS 107 may be divided into a number of cells, with a radio transceiver apparatus serving each cell. A radio transceiver apparatus is commonly referred to as a node B in UMTS applications, but may also be referred to by those skilled in the art as a base station (BS), a base transceiver station (BTS), a radio base station, a radio transceiver, a transceiver function, a basic service set (BSS), an extended service set (ESS), an access point (AP), or some other suitable terminology. For clarity, two node Bs 108 are shown; however, the RNS 107 may include any number of wireless node Bs. The node Bs 108 provide wireless access points to a core network 104 for any number of mobile apparatuses. Examples of a mobile apparatus include a cellular phone, a smart phone, a session initiation protocol (SIP) phone, a laptop, a notebook, a netbook, a smartbook, a personal digital assistant (PDA), a satellite radio, a global positioning system (GPS) device, a multimedia device, a video device, a digital audio player (e.g., MP3 player), a camera, a game console, or any other similar functioning device. The mobile apparatus is commonly referred to as user equipment (UE) in UMTS applications, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. For illustrative purposes, three UEs 110 are shown in communication with the node Bs 108. The downlink (DL), also called the forward link, refers to the communication link from a node B to a UE, and the uplink (UL), also called the reverse link, refers to the communication link from a UE to a node B.

The core network 104, as shown, includes a GSM core network. However, as those skilled in the art will recognize, the various concepts presented throughout this disclosure may be implemented in a RAN, or other suitable access network, to provide UEs with access to types of core networks other than GSM networks.

In this example, the core network 104 supports circuit-switched services with a mobile switching center (MSC) 112 and a gateway MSC (GMSC) 114. One or more RNCs, such as the RNC 106, may be connected to the MSC 112. The MSC 112 is an apparatus that controls call setup, call routing, and UE mobility functions. The MSC 112 also includes a visitor location register (VLR) (not shown) that contains subscriber-related information for the duration that a UE is in the coverage area of the MSC 112. The GMSC 114 provides a gateway through the MSC 112 for the UE to access a circuit-switched network 116. The GMSC 114 includes a home location register (HLR) (not shown) containing subscriber data, such as the data reflecting the details of the services to which a particular user has subscribed. The HLR is also associated with an authentication center (AuC) that contains subscriber-specific authentication data. When a call is received for a particular UE, the GMSC 114 queries the HLR to determine the UE's location and forwards the call to the particular MSC serving that location.

The core network 104 also supports packet-data services with a serving GPRS support node (SGSN) 118 and a gateway GPRS support node (GGSN) 120. General packet radio service (GPRS) is designed to provide packet-data services at speeds higher than those available with standard GSM circuit-switched data services. The GGSN 120 provides a connection for the RAN 102 to a packet-based network 122. The packet-based network 122 may be the Internet, a private data network, or some other suitable packet-based network. The primary function of the GGSN 120 is to provide the UEs 110 with packet-based network connectivity. Data packets are transferred between the GGSN 120 and the UEs 110 through the SGSN 118, which performs primarily the same functions in the packet-based domain as the MSC 112 performs in the circuit-switched domain.

The UMTS air interface is a spread spectrum direct-sequence code division multiple access (DS-CDMA) system. The spread spectrum DS-CDMA spreads user data over a much wider bandwidth through multiplication by a sequence of pseudorandom bits called chips. The TD-SCDMA standard is based on such direct sequence spread spectrum technology and additionally calls for a time division duplexing (TDD), rather than a frequency division duplexing (FDD) as used in many FDD mode UMTS/W-CDMA systems. TDD uses the same carrier frequency for both the uplink (UL) and downlink (DL) between a node B 108 and a UE 110, but divides uplink and downlink transmissions into different time slots in the carrier.

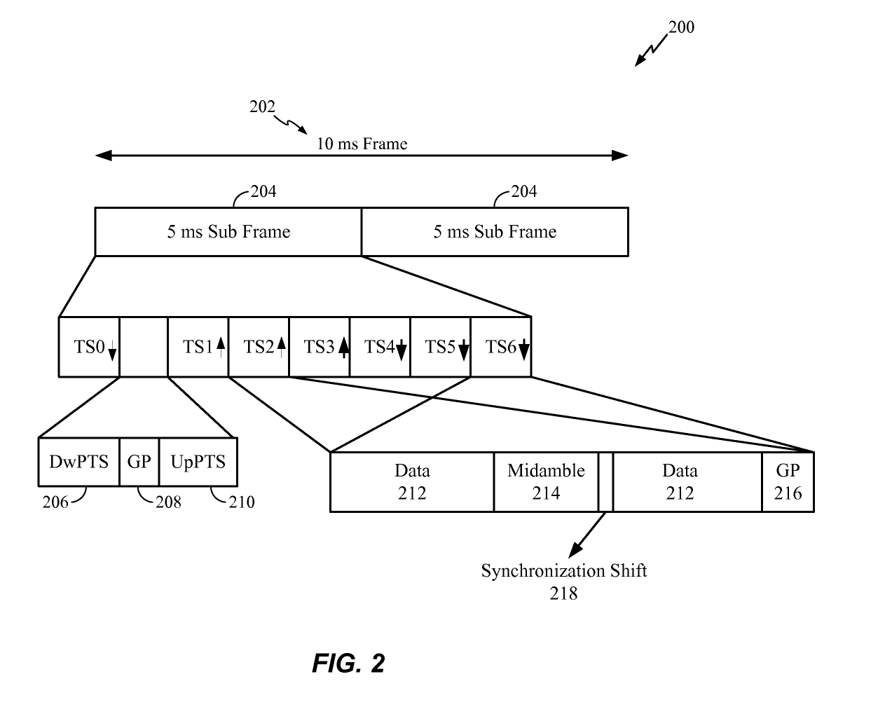

FIG. 2 shows a frame structure 200 for a TD-SCDMA carrier. The TD-SCDMA carrier, as illustrated, has a frame 202 that is 10 ms in length. The chip rate in TD-SCDMA is 1.28 Mcps. The frame 202 has two 5 ms subframes 204, and each of the subframes 204 includes seven time slots, TS0 through TS6. The first time slot, TS0, is usually allocated for downlink communication, while the second time slot, TS1, is usually allocated for uplink communication. The remaining time slots, TS2 through TS6, may be used for either uplink or downlink, which allows for greater flexibility during times of higher data transmission times in either the uplink or downlink directions. A downlink pilot time slot (DwPTS) 206, a guard period (GP) 208, and an uplink pilot time slot (UpPTS) 210 (also known as the uplink pilot channel (UpPCH)) are located between TS0 and TS1. Each time slot, TS0-TS6, may allow data transmission multiplexed on a maximum of 16 code channels. Data transmission on a code channel includes two data portions 212 (each with a length of 352 chips) separated by a midamble 214 (with a length of 144 chips) and followed by a guard period (GP) 216 (with a length of 16 chips). The midamble 214 may be used for features, such as channel estimation, while the guard period 216 may be used to avoid inter-burst interference. Also transmitted in the data portion is some Layer 1 control information, including synchronization shift (SS) bits 218. Synchronization shift bits 218 only appear in the second part of the data portion. The synchronization shift bits 218 immediately following the midamble can indicate three cases: decrease shift, increase shift, or do nothing in the upload transmit timing. The positions of the synchronization shift bits 218 are not generally used during uplink communications.

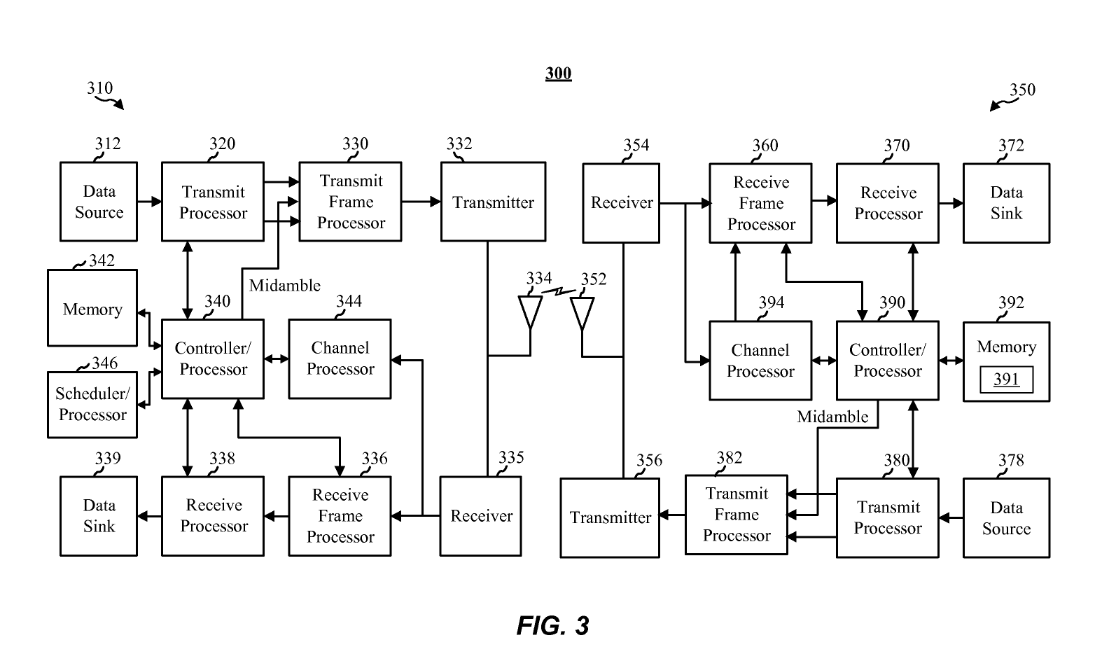

FIG. 3 is a block diagram of a node B 310 in communication with a UE 350 in a RAN 300, where the RAN 300 may be the RAN 102 in FIG. 1, the node B 310 may be the node B 108 in FIG. 1, and the UE 350 may be the UE 110 in FIG. 1. In the downlink communication, a transmit processor 320 may receive data from a data source 312 and control signals from a controller/processor 340. The transmit processor 320 provides various signal processing functions for the data and control signals, as well as reference signals (e.g., pilot signals). For example, the transmit processor 320 may provide cyclic redundancy check (CRC) codes for error detection, coding and interleaving to facilitate forward error correction (FEC), mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM), and the like), spreading with orthogonal variable spreading factors (OVSF), and multiplying with scrambling codes to produce a series of symbols. Channel estimates from a channel processor 344 may be used by a controller/processor 340 to determine the coding, modulation, spreading, and/or scrambling schemes for the transmit processor 320. These channel estimates may be derived from a reference signal transmitted by the UE 350 or from feedback contained in the midamble 214 (FIG. 2) from the UE 350. The symbols generated by the transmit processor 320 are provided to a transmit frame processor 330 to create a frame structure. The transmit frame processor 330 creates this frame structure by multiplexing the symbols with a midamble 214 (FIG. 2) from the controller/processor 340, resulting in a series of frames. The frames are then provided to a transmitter 332, which provides various signal conditioning functions including amplifying, filtering, and modulating the frames onto a carrier for downlink transmission over the wireless medium through smart antennas 334. The smart antennas 334 may be implemented with beam steering bidirectional adaptive antenna arrays or other similar beam technologies.

At the UE 350, a receiver 354 receives the downlink transmission through an antenna 352 and processes the transmission to recover the information modulated onto the carrier. The information recovered by the receiver 354 is provided to a receive frame processor 360, which parses each frame, and provides the midamble 214 (FIG. 2) to a channel processor 394 and the data, control, and reference signals to a receive processor 370. The receive processor 370 then performs the inverse of the processing performed by the transmit processor 320 in the node B 310. More specifically, the receive processor 370 descrambles and despreads the symbols, and then determines the most likely signal constellation points transmitted by the node B 310 based on the modulation scheme. These soft decisions may be based on channel estimates computed by the channel processor 394. The soft decisions are then decoded and deinterleaved to recover the data, control, and reference signals. The CRC codes are then checked to determine whether the frames were successfully decoded. The data carried by the successfully decoded frames will then be provided to a data sink 372, which represents applications running in the UE 350 and/or various user interfaces (e.g., display). Control signals carried by successfully decoded frames will be provided to a controller/processor 390. When frames are unsuccessfully decoded by the receive processor 370, the controller/processor 390 may also use an acknowledgement (ACK) and/or negative acknowledgement (NACK) protocol to support retransmission requests for those frames.

In the uplink, data from a data source 378 and control signals from the controller/processor 390 are provided to a transmit processor 380. The data source 378 may represent applications running in the UE 350 and various user interfaces (e.g., keyboard). Similar to the functionality described in connection with the downlink transmission by the node B 310, the transmit processor 380 provides various signal processing functions including CRC codes, coding and interleaving to facilitate FEC, mapping to signal constellations, spreading with OVSFs, and scrambling to produce a series of symbols. Channel estimates, derived by the channel processor 394 from a reference signal transmitted by the node B 310 or from feedback contained in the midamble transmitted by the node B 310, may be used to select the appropriate coding, modulation, spreading, and/or scrambling schemes. The symbols produced by the transmit processor 380 will be provided to a transmit frame processor 382 to create a frame structure. The transmit frame processor 382 creates this frame structure by multiplexing the symbols with a midamble 214 (FIG. 2) from the controller/processor 390, resulting in a series of frames. The frames are then provided to a transmitter 356, which provides various signal conditioning functions including amplification, filtering, and modulating the frames onto a carrier for uplink transmission over the wireless medium through the antenna 352.

The uplink transmission is processed at the node B 310 in a manner similar to that described in connection with the receiver function at the UE 350. A receiver 335 receives the uplink transmission through the antenna 334 and processes the transmission to recover the information modulated onto the carrier. The information recovered by the receiver 335 is provided to a receive frame processor 336, which parses each frame, and provides the midamble 214 (FIG. 2) to the channel processor 344 and the data, control, and reference signals to a receive processor 338. The receive processor 338 performs the inverse of the processing performed by the transmit processor 380 in the UE 350. The data and control signals carried by the successfully decoded frames may then be provided to a data sink 339 and the controller/processor, respectively. If some of the frames were unsuccessfully decoded by the receive processor, the controller/processor 340 may also use an acknowledgement (ACK) and/or negative acknowledgement (NACK) protocol to support retransmission requests for those frames.

The controller/processors 340 and 390 may be used to direct the operation at the node B 310 and the UE 350, respectively. For example, the controller/processors 340 and 390 may provide various functions including timing, peripheral interfaces, voltage regulation, power management, and other control functions. The computer-readable media of memories 342 and 392 may store data and software for the node B 310 and the UE 350, respectively. For example, the memory 392 of the UE 350 may store a tune away module 391 which, when executed by the controller/processor 390, configures the UE 350 to determine whether to abort a tune away procedure according to aspects of the present disclosure. A scheduler/processor 346 at the node B 310 may be used to allocate resources to the UEs and schedule downlink and/or uplink transmissions for the UEs.

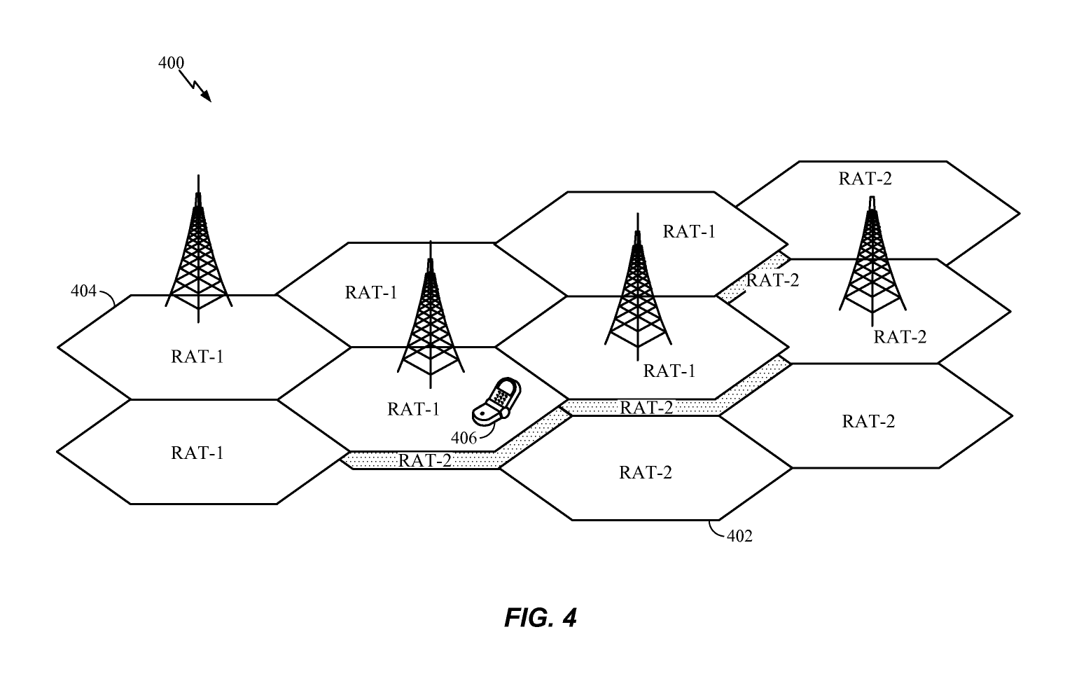

Some networks may be deployed with multiple radio access technologies. FIG. 4 illustrates a network utilizing multiple types of radio access technologies (RATs), such as but not limited to GSM (second generation (2G)), TD-SCDMA (third generation (3G)), LTE (fourth generation (4G)) and fifth generation (5G). Multiple RATs may be deployed in a network to increase capacity. Typically, 2G and 3G are configured with lower priority than 4G. Additionally, multiple frequencies within LTE (4G) may have equal or different priority configurations. Reselection rules are dependent upon defined RAT priorities. Different RATs are not configured with equal priority.

In one example, the geographical area 400 includes RAT-1 cells 402 and RAT-2 cells 404. In one example, the RAT-1 cells are 2G or 3G cells and the RAT-2 cells are LTE cells. However, those skilled in the art will appreciate that other types of radio access technologies may be utilized within the cells. A user equipment (UE) 406 may move from one cell, such as a RAT-1 cell 402, to another cell, such as a RAT-2 cell 404. The movement of the UE 406 may specify a handover or a cell reselection.

The handover or cell reselection may be performed when the UE moves from a coverage area of a first RAT to the coverage area of a second RAT, or vice versa. A handover or cell reselection may also be performed when there is a coverage hole or lack of coverage in one network or when there is traffic balancing between a first RAT and the second RAT networks. As part of that handover or cell reselection process, while in a connected mode with a first system (e.g., TD-SCDMA) a UE may be specified to perform a measurement of a neighboring cell (such as GSM cell). For example, the UE may measure the neighbor cells of a second network for signal strength, frequency channel, and base station identity code (BSIC). The UE may then connect to the strongest cell of the second network. Such measurement may be referred to as inter radio access technology (IRAT) measurement.

The UE may send a serving cell a measurement report indicating results of the IRAT measurement performed by the UE. The serving cell may then trigger a handover of the UE to a new cell in the other RAT based on the measurement report. The measurement may include a serving cell signal strength, such as a received signal code power (RSCP) for a pilot channel (e.g., primary common control physical channel (PCCPCH)). The signal strength is compared to a serving system threshold. The serving system threshold can be indicated to the UE through dedicated radio resource control (RRC) signaling from the network. The measurement may also include a neighbor cell received signal strength indicator (RSSI). The neighbor cell signal strength can be compared with a neighbor system threshold. Before handover or cell reselection, in addition to the measurement processes, the base station IDs (e.g., BSICs) are confirmed and re-confirmed.

A user equipment (UE) may include more than one subscriber identity module (SIM) or universal subscriber identity module (USIM). A UE with more than one SIM may be referred to as a multi-SIM device. In the present disclosure, a SIM may refer to a SIM or a USIM. Each SIM may also include a unique international mobile subscriber identity (IMSI) and service subscription information. Each SIM may be configured to operate in a particular radio access technology. Moreover, each SIM may have full phone features and be associated with a unique phone number. Therefore, the UE may use each SIM to send and receive phone calls. That is, the UE may simultaneously communicate via the phone numbers associated with each individual SIM. For example, a first SIM card can be associated for use in a City A and a second SIM card may be associated for use in a different City B to reduce roaming fees and long distance calling fees. Alternately, a first SIM card may be assigned for personal usage and a different SIM card may be assigned for work/business purposes. In another configuration, a first SIM card provides full phone features and a different SIM card is utilized mostly for data services.

Many multi-SIM devices support multi-SIM multi-standby operation using a single radio frequency (RF) chain to transmit and receive communications. In one example, a multi-SIM device includes a first SIM dedicated to operate in a first RAT and a second SIM dedicated to operate in a second RAT. In one illustrative example, the multi-SIM device includes a first SIM configured to operate in fourth generation (4G) radio access technology (RAT) (e.g., LTE) and a second SIM configured to operate in a second/third generation (2G/3G) RAT, such as TD-SCDMA. The multi-SIM device may operate in other RATs known to those skilled in the art.

When a fourth generation radio access technology subscription is in a radio resource control (RRC) connected mode without voice traffic, the multi-subscriber identity module, multi-standby UE supports tuning away. For example, the UE tunes away from the fourth generation RAT to the second/third generation RAT with the least amount of interruption to the fourth generation connected mode operation. That is, the UE periodically tunes away from the fourth generation RAT to perform one or more communication activities for the second/third generation (2G/3G) RAT. The communication activities may include monitoring for a page on the second/third generation RAT, collecting broadcast control channel (BCCH) system information blocks (SIBs), performing cell reselection, etc. If a page is detected when the UE is tuned to the second/third generation RAT, the multi-subscriber identity module multi-standby UE suspends all operations of the fourth generation RAT and transitions to the second/third generation RAT. When a page is not detected on the second/third generation RAT, the UE tunes back or attempts to tune back to the fourth generation RAT and attempts to recover the original operation of the fourth generation RAT.

During a communication procedure for the first SIM, the UE tunes to monitor for a page on the second SIM of the second/third generation RAT. The communication procedure may be random access channel (RACH) procedure. After the UE tunes back to the fourth generation RAT, the UE attempts to continue the communication procedure for the first SIM. In some instances, however, the attempts to continue or complete the communication procedure fails, which may result in a dropped call associated with the fourth generation RAT. For example, after the UE tunes back to the fourth generation RAT, the UE continues to send schedule requests for which the fourth generation base station (e.g., eNodeB) does not allocate grants, until a call associated with the fourth generation RAT is dropped.

### Reduced Call Interruption During Tune Away in Multi-Subscriber Identity Module/Multi-Standby Device

Aspects of the present disclosure are directed to preventing or reducing call interruptions (e.g., dropped calls) on a multi-subscriber identity module (SIM) user equipment (UE) caused by tuning away. For example, tuning away from a first radio access technology (RAT) to a second RAT to perform communication activities for the second RAT causes a call on the first RAT to be interrupted or dropped. The tune away may occur during a communication procedure at the first RAT. The communication procedure may include a random access procedure, handover procedure, hybrid automatic repeat request (HARQ) transmission, etc. The communication activity performed when tuning away may include, but is not limited to, monitoring paging, collecting system information, performing handover, performing cell acquisition/re-acquisition or cell reselection, and/or performing a registration procedure. The UE may include a single receive chain. In another configuration, the UE may be configured to tune away to the second RAT and to perform the communication procedures at the first RAT using a single receive chain.

In one aspect of the disclosure, the UE performs the communication procedure on the first RAT in response to a page for a call on the first RAT of the UE. The UE then determines whether to abort a tune away procedure to a second SIM associated with the second RAT based on a type of the communication procedure running on a first SIM of the first RAT.

In addition to or alternative to the determination to abort the tuning away based on the communication procedure running on a first SIM of the first RAT, the UE can determine whether to abort the tune away procedure based on a characteristic of the intended tune away. The characteristic of the intended tune away may include a purpose of the tune away. The purpose of the tune away may include monitoring paging, collecting system information, performing cell acquisition/re-acquisition or cell reselection, and/or performing a registration procedure. For example, a UE may likely abort the tune away procedure when the tune away procedure includes collecting system information, performing cell acquisition/re-acquisition or cell reselection, and/or performing a registration procedure. The UE, however, may not abort the tune away procedure when the tune away procedure includes monitoring paging.

In one aspect of the disclosure, the characteristic of the intended tune away may include an expected duration of the tune away and/or a length of the tune away. For example, the likelihood of tuning away increases with a decrease in an expected length or duration of the tune away. In one instance, when an expected length of the tune away to monitor for a page in the second RAT is short, the UE may permit the tune away. However, when the expected length of the tune away to monitor for the page in the second RAT is long, the UE may prevent the tune away.

In another aspect of the disclosure, the UE may determine whether to tune away based on a signal quality of a serving cell of the first RAT for communicating on the first SIM. For example, the tune away may be permitted when the signal quality of the serving cell is above a threshold (i.e., good). Otherwise, when the signal quality of the serving cell is below the threshold (i.e., weak), the tune away is aborted.

In yet another aspect of the present disclosure, the tune away procedure is aborted when the type of communication procedure running on the first SIM of the first RAT is a communication procedure for a specified call, such as a time-sensitive call. For example, the communication procedure for the specified call may be a circuit switched fallback call procedure, voice over packet-switched radio access technology call (e.g., LTE) procedure or an emergency call procedure. The type of communication procedures triggering abort may also include handover or cell reselection when a serving cell signal quality is weak, random access channel procedure, system information collection and voice over packet-switched radio access technology call procedure.

The tune away procedure may be permitted when the type of communication procedure running on the first SIM of the first RAT is a procedure that may not be critically impacted by the tune away. For example, the tune away procedure may be permitted when the type of communication procedure running on the first SIM of the first RAT is a background data procedure, cell reselection procedure, handover procedure, inter radio access technology (IRAT) or inter-frequency measurement procedure when the serving cell signal quality is above a threshold.

The tune away procedure may be aborted when a predefined (e.g., maximum) allowed interrupt time for a communication procedure running on the first SIM of the first RAT is less than a duration of the tune away to the second SIM of the second RAT. As noted, the communication procedure may be random access procedure, handover procedure, hybrid automatic repeat request (HARQ) transmission, etc. The tune away procedure, however, may be performed when the predefined allowed interrupt time for the communication procedure running on the first SIM of the first RAT exceeds a duration of the tune away to the second SIM.

The user equipment can determine whether to abort or perform the tune away procedure based on a percentage of completion of the communication procedure running on the first SIM of the first RAT. For example, the tune away procedure may be aborted when the communication procedure is almost completed.

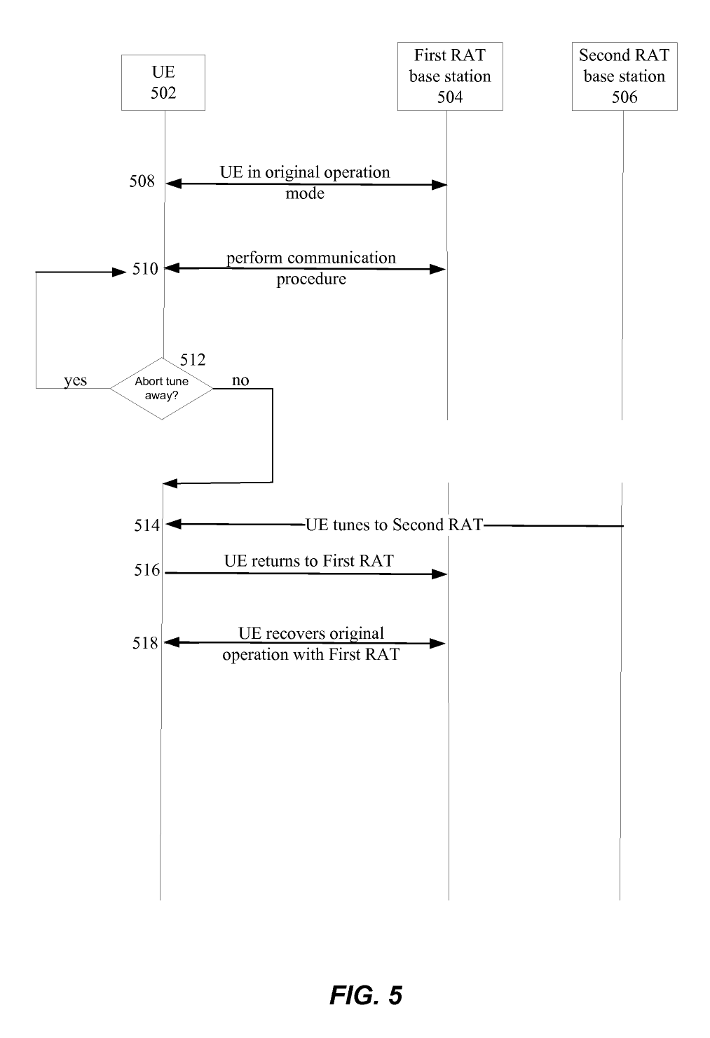

FIG. 5 illustrates an example of a call flow diagram for a tune away method for the multi-SIM multi-standby device in a wireless network according to aspects of the present disclosure. In one aspect of the disclosure, the communications of the tune away method are implemented with a single transmit/receive chain of the multi-SIM multi-standby device.

At time 508, a user equipment (UE) 502 is in an original operation mode, such as a connected mode or a dedicated channel (DCH) mode with a network of a first RAT (e.g., LTE). At time 510, the UE performs communication procedures corresponding to the original operation mode, such as a random access procedure, a handover procedure, hybrid automatic repeat request (HARQ) transmission, etc. For example, the UE 502 communicates with a base station 504 of the first RAT in response to a page for a call on the first RAT of the UE.

The UE 502 may be scheduled for tune away at a predefined time. For example, the UE 502 may be scheduled to periodically tune away to perform communication activities for the second RAT. To avoid call interruptions (e.g., call drop) caused by the expected tune away procedure, the UE 502 determines whether to abort the tune away procedure, as shown at time 512.

When the UE determines to abort the tune away procedure, the UE 502 continues to perform the communications procedures at the first RAT, as shown at time 510. Otherwise, at time 514, the UE 502 tunes away from the base station 504 of the first RAT to perform communication activities for the second RAT. For example, the UE 502 tunes its receive chain away from the base station 504 of the first RAT to the base station 506 of the second RAT to monitor downlink communications from the base station 506 of the second RAT. At time 516, the UE returns to the first RAT. At time 518, the UE recovers or attempts to recover the original operation with the first RAT.

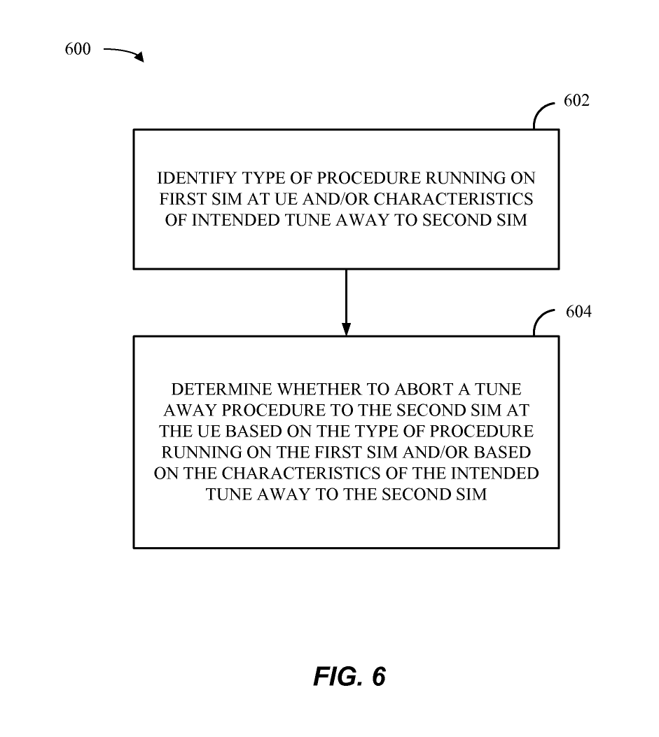

FIG. 6 shows a wireless communication method 600 according to aspects of the disclosure. A user equipment (UE) identifies a type of procedure running on a first subscriber identity module (SIM) at the UE and/or a characteristic of the intended tune away to a second SIM, as shown in block 602. The UE independently determines whether to abort a tune away procedure to the second subscriber identity module (SIM) at the UE based on the type of procedure running on the first SIM at the UE and/or based on the characteristic of the intended tune away to the second SIM, as shown in block 604.

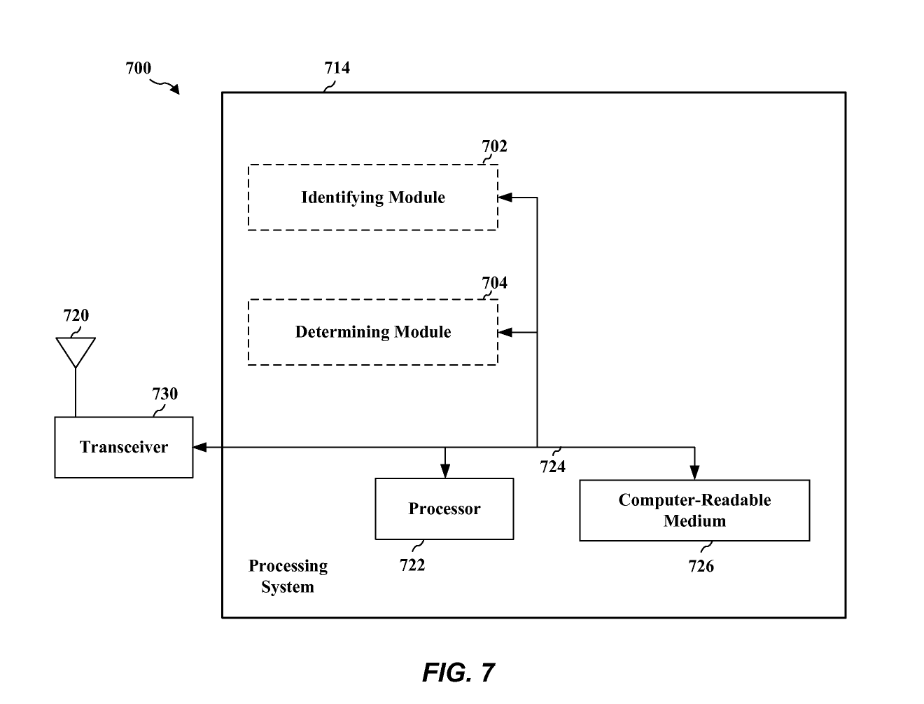

FIG. 7 is a diagram illustrating an example of a hardware implementation for an apparatus 700 employing a processing system 714. The processing system 714 may be implemented with a bus architecture, represented generally by the bus 724. The bus 724 may include any number of interconnecting buses and bridges depending on the specific application of the processing system 714 and the overall design constraints. The bus 724 links together various circuits including one or more processors and/or hardware modules, represented by the processor 722, the modules 702, 704 and the non-transitory computer-readable medium 726. The bus 724 may also link various other circuits such as timing sources, peripherals, voltage regulators, and power management circuits, which are well known in the art, and therefore, will not be described any further.

The apparatus includes a processing system 714 coupled to a transceiver 730. The transceiver 730 is coupled to one or more antennas 720. The transceiver 730 enables communicating with various other apparatuses over a transmission medium. The processing system 714 includes a processor 722 coupled to a non-transitory computer-readable medium 726. The processor 722 is responsible for general processing, including the execution of software stored on the computer-readable medium 726. The software, when executed by the processor 722, causes the processing system 714 to perform the various functions described for any particular apparatus. The computer-readable medium 726 may also be used for storing data that is manipulated by the processor 722 when executing software.

The processing system 714 includes an identifying module 702 for identifying a type of procedure running on a first subscriber identity module (SIM) at the UE and/or a characteristic of the intended tune away to a second SIM. The processing system 714 includes a determining module 704 for determining whether to abort a tune away procedure to the second subscriber identity module (SIM) at the UE based on the type of procedure running on the first SIM at the UE and/or based on the characteristic of the intended tune away to the second SIM. The modules may be software modules running in the processor 722, resident/stored in the computer-readable medium 726, one or more hardware modules coupled to the processor 722, or some combination thereof. The processing system 714 may be a component of the UE 350 and may include the memory 392, and/or the controller/processor 390.

In one configuration, an apparatus such as a UE is configured for wireless communication including means for identifying. In one aspect, the identifying means may be the antennas 352/720, the receiver 354, the transmitter 356, the transceiver 730, the channel processor 394, the receive frame processor 360, the receive processor 370, the transmit frame processor 382, the transmit processor 380, the controller/processor 390, the memory 392, the tuning away module 391, the identifying module 702, and/or the processing system 714 configured to perform the aforementioned means. In one configuration, the means functions correspond to the aforementioned structures. In another aspect, the aforementioned means may be a module or any apparatus configured to perform the functions recited by the aforementioned means.

The UE is also configured to include means for determining. In one aspect, the determining means may be the controller/processor 390, the memory 392, tuning away module 391, the determining module 704 and/or the processing system 714 configured to perform the aforementioned means. In one configuration, the means functions correspond to the aforementioned structures. In another aspect, the aforementioned means may be a module or any apparatus configured to perform the functions recited by the aforementioned means.

Several aspects of a telecommunications system has been presented with reference to LTE, TD-SCDMA, 5G (fifth generation) and GSM systems. As those skilled in the art will readily appreciate, various aspects described throughout this disclosure may be extended to other telecommunication systems, network architectures and communication standards, including those with high throughput and low latency such as 4G systems, 5G systems and beyond. By way of example, various aspects may be extended to other UMTS systems such as W-CDMA, high speed downlink packet access (HSDPA), high speed uplink packet access (HSUPA), high speed packet access plus (HSPA+) and TD-CDMA. Various aspects may also be extended to systems employing long term evolution (LTE) (in FDD, TDD, or both modes), LTE-Advanced (LTE-A) (in FDD, TDD, or both modes), CDMA2000, evolution-data optimized (EV-DO), ultra mobile broadband (UMB), IEEE 802.11 (Wi-Fi), IEEE 802.16 (WiMAX), IEEE 802.20, ultra-wideband (UWB), Bluetooth, and/or other suitable systems. The actual telecommunication standard, network architecture, and/or communication standard employed will depend on the specific application and the overall design constraints imposed on the system.

Several processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a non-transitory computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the term “signal quality” is non-limiting. Signal quality is intended to cover any type of signal metric such as received signal code power (RSCP), reference signal received power (RSRP), reference signal received quality (RSRQ), received signal strength indicator (RSSI), signal to noise ratio (SNR), signal to interference plus noise ratio (SINR), etc.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. A phrase referring to “at least one of” a list of items refers to any combination of those items, including single members. As an example, “at least one of: a, b, or c” is intended to cover: a; b; c; a and b; a and c; b and c; and a, b and c. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. A method of wireless communication in a multi-subscriber identity module (SIM) user equipment (UE), comprising:
identifying a type of procedure running on a first subscriber identity module (SIM) at a user equipment (UE) and/or a characteristic of an intended tune away to a second SIM; and
determining whether to abort tuning away from the first SIM to the second SIM at the UE to perform communication activities for the second SIM based at least in part on the type of procedure running on the first SIM at the UE and/or the characteristic of the intended tune away to the second SIM.

2. The method of claim 1, in which the characteristic comprises a purpose of the tune away to the second SIM.

3. The method of claim 1, in which the characteristic comprises a length of the tune away.

4. The method of claim 1, further comprising determining whether to tune away based at least in part on a signal quality of a first SIM serving cell.

5. The method of claim 1, further comprising aborting the tuning away when the type of procedure running on the first SIM is one of a circuit switched fallback call, a voice over packet-switched radio access technology call and an emergency call.

6. The method of claim 1, further comprising performing the tuning away when the type of procedure is one of a background data procedure, a cell reselection procedure, a handover procedure and an inter radio access technology (IRAT) or inter-frequency measurement when a serving cell signal quality is above a threshold.

7. The method of claim 1, further comprising aborting the tuning away when a predefined allowed interrupt time for a first SIM procedure is less than a duration of the tune away to the second SIM.

8. The method of claim 1, further comprising performing the tuning away when a predefined allowed interrupt time for a first SIM procedure exceeds a duration of the tune away to the second SIM.

9. The method of claim 1, further comprising aborting or performing the tuning away based at least in part on a percentage of completion of a first SIM procedure.

10. An apparatus for wireless communication in a multi-subscriber identity module (SIM) user equipment (UE), comprising:
means for identifying a type of procedure running on a first subscriber identity module (SIM) at a user equipment (UE) and/or a characteristic of an intended tune away to a second SIM; and
means for determining whether to abort tuning away from the first SIM to the second SIM at the UE to perform communication activities for the second SIM based at least in part on the type of procedure running on the first SIM at the UE and/or the characteristic of the intended tune away to the second SIM.

11. The apparatus of claim 10, in which the characteristic comprises a purpose of the tune away to the second SIM.

12. The apparatus of claim 10, in which the characteristic comprises a length of the tune away.

13. The apparatus of claim 10, further comprising determining whether to tune away based at least in part on a signal quality of a first SIM serving cell.

14. The apparatus of claim 10, further comprising means for aborting the tuning away when the type of procedure running on the first SIM is one of a circuit switched fallback call, a voice over packet-switched radio access technology call and an emergency call.

15. The apparatus of claim 10, further comprising means for performing the tuning away when the type of procedure is one of a background data procedure, a cell reselection procedure, a handover procedure and an inter radio access technology (IRAT) or inter-frequency measurement when a serving cell signal quality is above a threshold.

16. An apparatus for wireless communication in a multi-subscriber identity module (SIM) user equipment (UE), comprising:
a memory; and
at least one processor coupled to the memory and configured:
to identify a type of procedure running on a first subscriber identity module (SIM) at a user equipment (UE) and/or a characteristic of an intended tune away to a second SIM; and
to determine whether to abort tuning away from the first SIM to the second SIM at the user equipment (UE) to perform communication activities for the second SIM based at least in part on the type of procedure running on the first SIM at the UE and/or the characteristic of the intended tune away to the second SIM.

17. The apparatus of claim 16, in which the characteristic comprises a purpose of the tune away to the second SIM.

18. The apparatus of claim 16, in which the characteristic comprises a length of the tune away.

19. The apparatus of claim 16, in which the at least one processor is further configured to determine whether to tune away based at least in part on a signal quality of a first SIM serving cell.

20. The apparatus of claim 16, in which the at least one processor is further configured to abort the tuning away when the type of procedure running on the first SIM is one of a circuit switched fallback call, a voice over packet-switched radio access technology call and an emergency call.

21. The apparatus of claim 16, in which the at least one processor is further configured to perform the tuning away when the type of procedure is one of a background data procedure, a cell reselection procedure, a handover procedure and an inter radio access technology (IRAT) or inter-frequency measurement when a serving cell signal quality is above a threshold.

22. The apparatus of claim 16, in which the at least one processor is further configured to abort the tuning away when a predefined allowed interrupt time for a first SIM procedure is less than a duration of the tune away to the second SIM.

23. The apparatus of claim 16, in which the at least one processor is further configured to perform the tuning away when a predefined allowed interrupt time for a first SIM procedure exceeds a duration of the tune away to the second SIM.

24. The apparatus of claim 16, in which the processor is further configured to abort or perform the tuning away based at least in part on a percentage of completion of a first SIM procedure.

25. A non-transitory computer-readable medium having program code recorded thereon, the program code comprising:
program code to identify a type of procedure running on a first subscriber identity module (SIM) at a user equipment (UE) and/or a characteristic of an intended tune away to a second SIM; and
program code to determine whether to abort tuning away from the first SIM to the second SIM at the user equipment (UE) to perform communication activities for the second SIM based at least in part on the type of procedure running on the first SIM at the UE and/or the characteristic of the intended tune away to the second SIM.

26. The computer-readable medium of claim 25, in which the characteristic comprises a purpose of the tune away to the second SIM.

27. The computer-readable medium of claim 25, in which the characteristic comprises a length of the tune away.

28. The computer-readable medium of claim 25, further comprising program code to determine whether to tune away based at least in part on a signal quality of a first SIM serving cell.

29. The computer-readable medium of claim 25, further comprising program code to abort the tuning away when the type of procedure running on the first SIM is one of a circuit switched fallback call, a voice over packet-switched radio access technology call and an emergency call.

30. The computer-readable medium of claim 25, further comprising program code to perform the tuning away when the type of procedure is one of a background data procedure, a cell reselection procedure, a handover procedure and an inter radio access technology (IRAT) or inter-frequency measurement when a serving cell signal quality is above a threshold.
